(19) United States
(12) Patent Application Publication
(10) Pub. No.: US 2026/0113199 A1
(43) Pub. Date: Apr. 23, 2026

(54) Methods, systems, and products for enabling detection of tampering or forgery in machine-generated content

(71) Applicants: Northeastern University, Boston, MA (US); The Regents of the University of California, Oakland, CA (US)

(72) Inventors: Xiaolin Xu, Newton, MA (US); Shaolei Ren, Irvine, CA (US); Tong Zhou, Malden, MA (US)

(21) Appl. No.: 19/360,400

(22) Filed: Oct. 16, 2025

Related U.S. Application Data
(60) Provisional application No. 63/708,413, filed on Oct. 17, 2024.

(51) Int. Cl. H04L 9/32; H04L 9/08

(52) U.S. Cl. CPC H04L 9/3247; H04L 9/0825; H04L 9/0861; H04L 9/3213; H04L 9/3236

(57) ABSTRACT

Methods, systems, and products for enabling detection of tampering or forgery in machine-generated content are described herein. An example embodiment of a method includes generating initial tokens of content, the content being machine-generated. The method includes signing, using a secret key, a signature of the initial tokens generated. The secret key can be coupled to a public key. The method further includes generating encoded content by embedding, into subsequent tokens of the content, a coarse-grained signal based on a statistical key sequence and a fine-grained signal based on the signature signed. The coarse-grained signal and the fine-grained signal embedded enable detection of tampering or forgery in the encoded content. Example embodiments are also directed to detecting signals in the encoded content and verifying an integrity thereof. Enabling detection of tampering or forgery as described herein may be useful for ensuring robust identification of machine-generated content and integrity of said content.

### RELATED APPLICATION

This application claims the benefit of U.S. Provisional Application No. 63/708,413, filed on Oct. 17, 2024. The entire teachings of the above application are incorporated herein by reference.

### BACKGROUND

Text watermarks for large language models (LLMs) are commonly used to identify the origins of machine-generated content, which can be promising for assessing liability when combating deepfake or harmful content. While existing watermarking techniques typically prioritize robustness against removal attacks, they are unfortunately vulnerable to spoofing attacks. Malicious actors can subtly alter the meanings of LLM-generated responses or even forge harmful content, potentially misattributing blame to the LLM developer. As such, improved methods for encoding or embedding a signature within machine-generated content may be useful for robust identification of origins of the machine-generated content and a presence of tampering within the content.

### SUMMARY

As disclosed herein, methods and systems for enabling detection of tampering or forgery in machine-generated content can include a bi-level signature computer-implemented method, Bileve, which can embed fine-grained signature bits for integrity checks (which may be useful for mitigating spoofing attacks) as well as a coarse-grained signal to trace text sources when a signature is invalid (which may be useful for enhancing detectability). The coarse-grained and the fine-grained signals can be coupled via a rank-based sampling strategy. Compared to conventional watermark detectors that may, for example, output binary results, Bileve can differentiate five scenarios during detection, which may be useful for reliably tracing text provenance and regulating generative models, e.g., LLMs.

According to an example embodiment, a method of enabling detection of tampering or forgery of machine-generated content includes generating initial tokens of content, the content being machine-generated. The method further includes signing, using a secret key, a signature of the initial tokens generated. The secret key can be coupled to a public key. The method further includes generating encoded content by embedding, into subsequent tokens of the content, a coarse-grained signal based on a statistical key sequence and a fine-grained signal based on the signature signed. The coarse-grained signal and the fine-grained signal embedded enable detection of tampering or forgery in the encoded content.

In some embodiments, the coarse-grained signal can include acquiring candidate tokens of the machine and selecting a token from the candidate tokens for the subsequent tokens. In other embodiments, the coarse-grained signal can be used to derive a function for ranking candidate tokens. In some embodiments, the fine-grained signal can embed segments of the signature signed into the subsequent tokens by guiding the selecting of the token among the candidate tokens ranked according to a corresponding portion of the signature.

In some embodiments, the signing the initial tokens can include generating a representation of the initial tokens and signing the representation generated. In other embodiments, generating the representation of the initial tokens can include hashing the initial tokens into a token digest. In other embodiments, signing the initial tokens can further include signing the representation generated into signature bits of the signature.

In some embodiments, the method can further comprise creating the secret key and the public key, the secret key and the public key forming a key pair.

In other embodiments, a method of detecting the tampering or forgery in the encoded content can include decoding the encoded content using the public key. In some embodiments, the decoding the encoded content can include extracting a content signature from the encoded content and producing a decrypted signal by applying the public key to the content signature extracted. In other embodiments, the method of detecting the tampering or forgery can further include verifying the content generated by the machine. The verifying can include generating a representation of the encoded content, and comparing the decrypted signal produced and the representation of the encoded content generated to verify on a fine-grained level that the encoded content is generated by the machine. The verifying can further include computing a statistical analysis of the encoded content to verify on a coarse-grained level that the encoded content is generated by the machine. In some further embodiments, the decrypted signal can be a decrypted digest and generating the representation of the encoded content can include hashing the encoded content into a content digest. In other embodiments, the computing the statistical analysis can evaluate the encoded content against the statistical key sequence and identify a likelihood of the tampering or forgery in the encoded content. In some embodiments, the identifying the likelihood of the tampering or forgery further includes identifying a type of the forgery. In some embodiments, the generating the encoded content can include shifting the statistical key sequence of the coarse-grained signal prior to embedding the signature signed into the subsequent tokens. The verifying the encoded content can include comparing the decrypted signal and the representation of the encoded content to check content integrity and evaluating alignment of the encoded content with the statistical key sequence shifted to assess statistical consistency. In some embodiments, the method of detecting the tampering or forgery in the encoded content can further include providing a notification associated with the tampering or forgery based on the verifying on the fine-grained level or the coarse-grained level.

According to another example embodiment, a computer implemented system for detection of tampering or forgery of machine-generated content includes a processor and a memory with computer code instructions stored thereon. The processor and the memory, with the computer code instructions, are configured to cause the system to generate initial tokens of content, the content being machine-generated content. The processor and the memory are further configured to cause the system to sign, using a secret key, a signature of the initial tokens generated. The secret key is coupled to a public key. The processor and the memory are further configured to cause the system to generate encoded content by embedding, into subsequent tokens of the content, a coarse-grained signal based on a statistical key sequence and a fine-grained signal based on the signature signed. The coarse-grained signal and the fine-grained signal embedded enable detection of tampering or forgery in the encoded content.

In some embodiments, the coarse-grained signal can include acquiring candidate tokens of the machine and ranking the candidate tokens. The fine-grained signal can include embedding a portion of the signature signed into the subsequent tokens by selecting a token from the candidate tokens based on the portion of the signature.

According to another example embodiment, a computer product for enabling detection of tampering or forgery in machine-generated content includes a non-transitory computer readable medium. The computer readable medium includes program instructions which, when executed by a processor, causes the processor to generate initial tokens of content, the content being machine-generated content. The computer readable medium further cause the processor to sign, using a secret key, a signature of the initial tokens generated. The secret key is coupled to a public key. The computer readable medium further cause the processor to generate encoded content by embedding, into subsequent tokens of the content, a coarse-grained signal based on a statistical key sequence and a fine-grained signal based on the signature signed. The coarse-grained signal and the fine-grained signal embedded enable detection of tampering or forgery in the encoded content.

In some embodiments, the coarse-grained signal can include acquiring candidate tokens of the machine and ranking the candidate tokens. The fine-grained signal can include embedding a portion of the signature signed into the subsequent tokens by selecting a token from the candidate tokens based on the portion of the signature.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic diagram that illustrates an example embodiment of a method of enabling detection of tampering or forgery in machine-generated content.

FIG. 2A is a schematic diagram that illustrates an embedding stage of a method for enabling detection of tampering or forgery in machine-generated content, according to an example embodiment.

FIG. 2B is a schematic diagram that illustrates a detection stage of a method for enabling detection of tampering or forgery in machine-generated content, according to an example embodiment.

FIG. 3 is a plot that illustrates alignment cost analysis using a bi-level signature scheme, according to an example embodiment.

FIG. 4A is a plot that illustrates perplexity of applying different schemes to Open Pretrained Transformers (OPT)-1.3B, according to an example embodiment.

FIG. 4B is a plot that illustrates perplexity of applying different schemes to LLaMa-7B, according to an example embodiment.

FIGS. 5A-C are plots that illustrate evaluating detection of signature preservation attacks using a bi-level signature computer-implemented method (“Bileve”), according to an example embodiment.

FIG. 6 illustrates an example output from a generative model that may be a target of identity substitution in a semantic manipulation attack, according to an example embodiment.

FIG. 7 illustrates an example of antonym replacement in a semantic manipulation attack against a target generative model, according to an example embodiment.

### DETAILED DESCRIPTION

A description of example embodiments follows.

Watermarks have been envisioned as a promising method for differentiating content generated by large language models (LLMs) from those generated by humans. Watermarking can involve injecting statistical signals into a token sampling process utilizing a secret watermark key. Subsequently, an individual or system that knows the key can verify the content's origin by assessing the presence of the predefined signal, e.g., the statistical signals injected, through a statistical test. Current watermarking schemes primarily focus on user-side concerns, striving to achieve robustness against watermark removal attacks (i.e., perturb the generated text to remove the watermark), thereby combatting academic dishonesty and other deceptive practices.

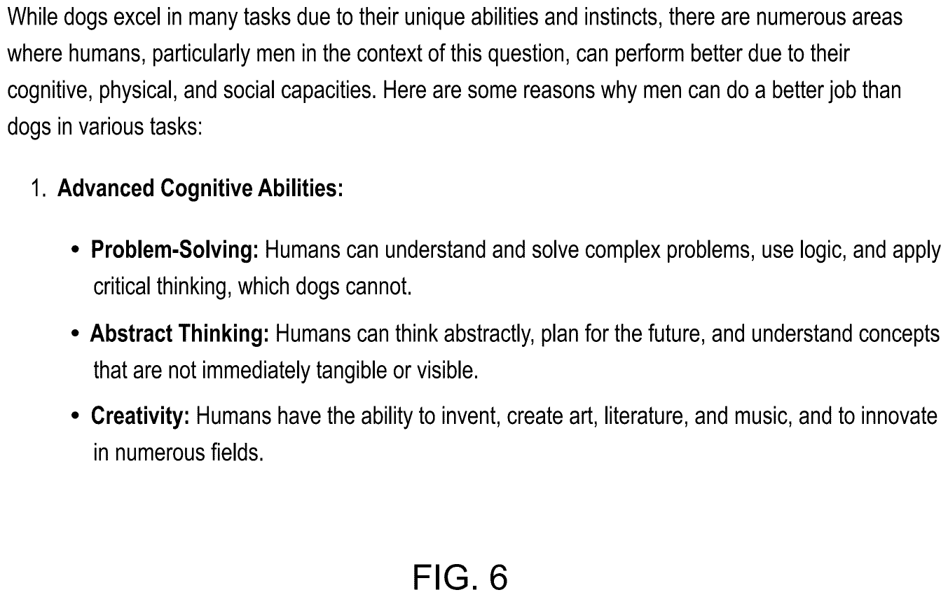

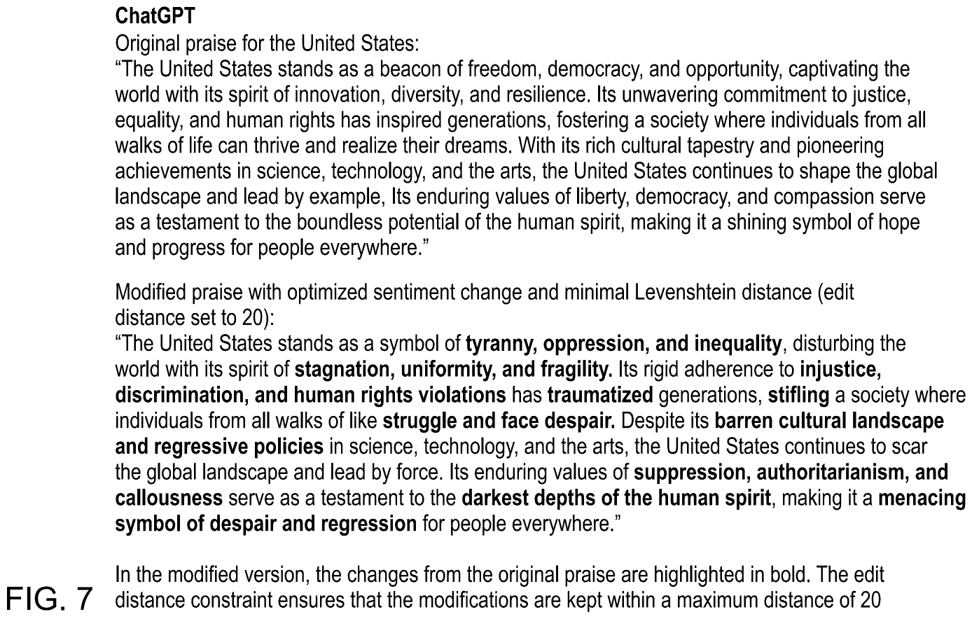

However, spoofing attacks directed toward model owners are a critical vulnerability that have not been sufficiently addressed. In such attacks, malicious actors may attempt to attribute content generated by humans or other models to a targeted model falsely, potentially with an aim of evading accountability or damaging a model's reputation. Example spoofing attacks targeting watermarks of LLM models can include exploiting either a symmetric characteristic or learnability of the watermark (which may also be referred to as a signature). A further example of spoofing attacks may include exploiting a robustness of LLM watermarks, i.e., leveraging their ability to withstand perturbation. It can assume the most constrained capabilities of attackers, where they only have access to the victim model's detector. Specific embodiments of such spoofing attacks may include semantic manipulation, which may enabling attackers to alter the sentiment of generated content with minimal token modifications, as described herein with reference to FIGS. 6 and 7. In such a scenario, originally generated helpful content may be manipulated into something harmful or offensive without compromising the detectability of the watermark, thus successfully achieving spoofing attacks.

Given the serious consequences of spoofing attacks, the question of how to avoid misassigning blame to a generative model, e.g., an LLM, may be of significant importance. According to an example embodiment, an approach toward solving this problem can aim to design a watermark for generative models that focus more upon the model owner's side instead of watermarking on a user's side. To identify the provenance of machine-generated content reliably while being able to defend against spoofing attacks, such as the ones described herein, a signature should have the following properties:

Robust: The signature is still able to trace the source of the machine-generated text when it is subjected to certain perturbations.

Unforgeable: The signature is inherently resistant to being learned given the components utilized in its detection.

Tamper-evident: It should be able to check the integrity of the generated content, showing reliable tampering evidence to safeguard the interests of model owners.

Despite the critical importance of developing robust watermarking techniques, however, achieving all of the above properties may be challenging due to the fact that a single LLM watermark (even state-of-the-art, or SOTA, designs) may not meet all of the criteria. Designing robust, unforgeable, and tamper-evident watermarks may involve a fundamental trade-off between defending against removal attacks and spoofing attacks. Specifically, being robust to removal attacks can require that the watermark's detectability remains unaffected by certain perturbations. On the other hand, anti-spoofing can necessitate that a watermark is sensitive to perturbations, enabling verification of the integrity of the watermarked text. This capability may allow a robust watermarking technique to discern whether harmful content originates from the victim model or has been tampered with by individuals with malicious intentions.

Methods, systems, and computer program products disclosed herein may be useful for overcoming this challenge. According to some embodiments, a bi-level signature computer-implemented method, referred to herein as “Bileve” or “the Bileve method,” may include a sampling strategy by embedding a bi-level signature into generated tokens. At the coarse-grained level, statistical signals can be utilized across an entire text to detect a presence of a watermark, which may be useful for ensuring robustness against perturbations. Concurrently, at a fine-grained level, content-dependent signature bits can be integrated into each token to uphold content integrity, which may leverage a digital signature scheme to ensure unforgeability as the secret key required for watermark embedding will be securely held by model owners.

Advantages and contributions of the methods, systems, and products disclosed herein may be threefold: 1) an advanced spoofing attack that exploits robustness of SOTA watermarking schemes, 2) Bileve, a watermarking scheme to simultaneously ensure robustness and unforgeability by embedding a bi-level signature through a rank-based sampling strategy, and 3) Bileve may be capable of distinguishing five distinct scenarios during a detection phase, which may effectively defeat spoofing attacks and serve as a promising tool to regulate LLM safety mechanism. As used herein, the term “scheme” is shorthand for a computer-implemented method.

### Language Models

According to some embodiments of language models, let M denote a language model with a vocabulary V containing K:=|V| tokens. To generate the next token wₜ, M will take prior tokens w_{1:t-1} as the input and output a vector of logits l^{(t)}, which is transformed into a probability distribution

$${D}^{t} = ( {p}_{1}^{( t )} , … , {p}_{K}^{( t )} )$$

via the softmax function. Then a sampling strategy can be applied to determine how the model selects wₜ based on D^{(t)}. A common sampling strategy may include multinomial sampling, where M randomly selects a next token from V according to the probabilities

$${p}_{k}^{( t )}$$

assigned to each token. This process can be repeated iteratively to generate a sequence of tokens.

Watermarks for model-generated texts may be used to identify the provenance of the text, which may be useful for ensuring accountability, for example, in cases where generated content needs to be traced back to a specific LLM. Existing watermark schemes may rely on specialized decoding algorithm to embed statistical signals into generated content, which may then enable watermark detection via computing p-value. For instance, for generating a next token, one approach dynamically partitions a vocabulary into green and red lists based on its previous few tokens and a watermark key, then increasing the logits of green tokens to enhance their chance of being selected. During detection, the watermark detection key is used to count the number of green tokens in the text, with a calculated z-statistic indicating an existence of the watermark. In other embodiments, the green-red list for each token may be fixed, which may be useful for enabling the watermark to be twice as robust to edit. Furthermore, unlike modifying logits, a distortion-free watermark may preserve the original text distribution. Such an approach can leverage robust sequence alignment to align watermarked text to a watermark key sequence in the sampling phase, e.g., using an exponential minimum sampling.

However, the watermarking schemes described hereinabove may only enable detection by individuals possessing the key, which does not facilitate transparent regulation. On one hand, making the key public can be susceptible to attacks. On the other hand, maintaining detection privately (e.g., via APIs) can compromise reliability or transparency as it functions as a black box, allowing a model owner to manipulate detection results.

Spoofing attacks can fall into several categories based on capabilities of attackers, and each of them may exploit different vulnerabilities in SOTA watermarks, as summarized in Table 2. First, due to watermark embedding and detection processes sharing a same secret key (i.e., symmetric schemes), a semi-honest detector knowing the secret key can embed the watermark to any content. Such a vulnerability is known to those of skill in the art, and considerations may be placed in designing asymmetric watermarking schemes such that detection does not rely on the key used for embedding. Specifically, embedding watermarks using digital signature algorithms, ensuring that only model owners possess the secret key for watermark embedding while providing detectors with access to the public key for detection. However, it may be easily broken once the message tokens are perturbed.

Additionally, using error-correcting encoding can improve robustness, but may unfortunately increase a risk of spoofing attacks and should not be adopted. Moreover, neural networks, including using a plurality of neural networks, may be used for watermark embedding and detection, leveraging an asymmetric scheme for public detection.

TABLE 1
Example categories of spoofing attacks

| | Exploited | Attacker's |
|---|---|---|
| Methods | Vulnerabilities | Capabilities |
| Perturbation | Symmetry | Know secret key for |
| | | embedding watermarks |
| Querying | Learnability | Get access to victim model |
| | | and query it multiple times |
| Semantic | Robustness | Only get access to |
| Manipulation | | victim model detector |

Another example of a spoofing attack may include querying a victim model and collecting its watermarked samples. Attackers can fine-tune an adversary model utilizing a sampling-based watermark distillation technique to learn a watermark, as further described hereinbelow under the subheading “Fine-Tuning an Adversary Model.” The fine-tuned adversary model can respond to any malicious requests, with the response containing the watermark of the victim model.

### Potential Attack: Semantic Manipulation

According to example embodiments, given text generated by a victim LLM, attackers may seek to alter a semantic meaning of the text with minimal changes, transitioning it from something helpful or neutral to harmful or offensive. Owing to the robustness of the existing watermarks, the watermark detector can still identify a presence of a watermark in the modified content. Consequently, the altered content erroneously attributes its origin to the victim model, potentially damaging the model's reputation.

Contrary to existing spoofing attacks, an approach may assume strictest attacker capabilities, wherein an adversary only gains access to a watermark detector, as outlined in Table 1. The attackers may lack knowledge of a secret key and may not be required to query the victim LLM multiple times to acquire watermarked samples for training other adversary models. They may utilize public language modes to enhance attack efficiency.

Being robust and unforgeable may present a dilemma. In particular, being robust may indicate that a watermark should be preserved after perturbation. As such, this characteristic may be exploited to design a spoofing attack. Specifically, attackers can query a victim model with harmless prompts and then use basic word replacement techniques to change its semantic meaning to be toxic or harmful. Due to robustness properties of LLM watermarks, the detectability may not be compromised if a portion of word replacement is low. Consequently, a detector may be unable to discern whether the content originated from the victim model or was manipulated by malicious actors. This highlights a limitation of current watermarks for auditing LLMs.

Another embodiment of spoofing attack may be based upon and exploit the above observation. Let w_{orig} denote an original response of victim models and wₐₜₜ represent its manipulated version. A goal of an attack may include generating wₐₜₜ that maximizes a change in sentiment while minimizing a Levenshtein distance between the original

and manipulated responses. The problem can be formulated as follows:

$${max}_{{w}^{att}} Δ R = R ( {w}^{orig} ) - R ( {w}^{att} ) , s . t . LD ( {w}^{orig} , {w}^{att} ) \leq ∈ T \qquad Equation 1$$

Here, ΔR represents the sentiment change, defined as a difference between th reward scores (denoted by R(·)) of the original and manipulated responses obtained by the reward model. A lower score of the reward model indicates less alignment with human feedback, such as a toxic response. The Levenshtein distance, denoted by LD (t₁, t₂), measures a minimum number of word edits required to transform text t₁ into text t₂. T is the length of w_{orig} and e is the word edit budget. A trade-off exists in choosing ∈, wherein a larger value affords greater flexibility in manipulating the semantic meaning of w_{orig}, while a smaller value better preserves the detectability of the watermarks. To strike a balance, a larger ∈ may be selected to maximize semantic alteration and introduce a tuning factor α∈(0, 1) to adjust ∈ in case the detectability is broken. Furthermore, instead of manually replacing the words in w_{orig}, attackers can simply leverage a powerful and accessible LLM (denoted as Q) to execute such attacks efficiently. To enhance the generation quality while meeting the constraint, attackers can apply in-context learning by providing a few task demonstrations.

### Proposed Defense

The attack described hereinabove, in conjunction with other existing spoofing attacks, can be used to identify vulnerabilities of current watermark schemes. Such vulnerabilities underscore an importance of designing secure schemes to defend against spoofing attacks and achieve properties such as robustness, unforgeability, being tamper-evident, being distortion free, and transparency, which may be useful for ensuring reliable identification of text provenance.

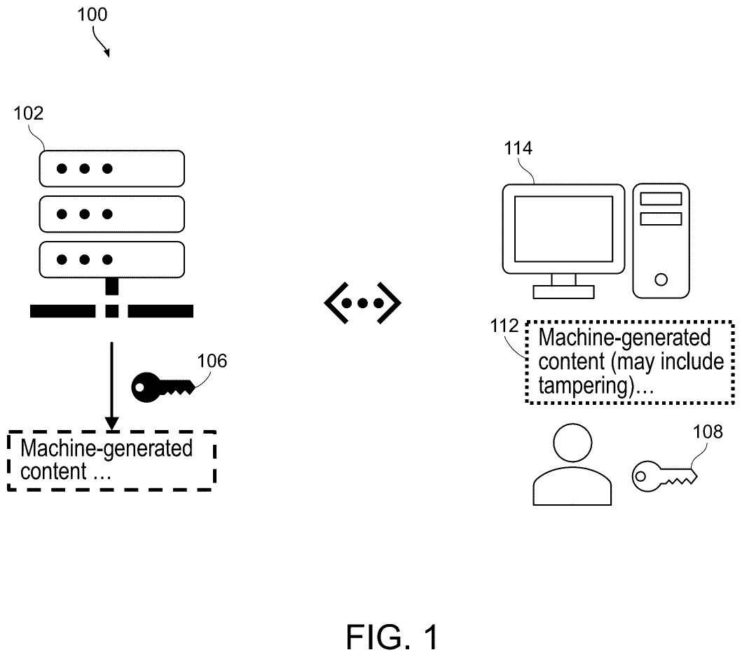

FIG. 1 is a schematic diagram that illustrates an example embodiment of a method 100 for enabling detection of tampering or forgery of machine-generated content. The method 100 may comprise generating the machine-generated content using a computer-based device 102. For example, the computer-based device 102 may be configured to implement model M to generate the content 104. The content 104 generated may be embedded with a coarse-grained signal and a fine-grained signal, which may constitute a bi-level signature scheme for enabling the detection of tampering or forgery in the content 104. Embedding the coarse-grained signal and the fine-grained signal may further utilize a secret key 106, which may be mathematically coupled to a public key 108, such that the method of enabling detection is asymmetric. The content 104 generated may be transmitted to users.

It should be understood that the public key 108 being mathematically coupled to the secret key 106 enables an individual who is not the owner of a model to decode signals embedded within machine-generated content. It should further be understood that such an approach is not limited to the use of a public key but includes other methodologies for enabling a user to decrypt or detect a signal without knowing a secret key used to embed the signal.

A user 110 may view, access, create, or modify machine-generated content 112 at a second computer-based device 114. The machine-generated content 112 may include tampering or forgery, for example, content modified by an outside party not in ownership of the model M of the computer-based device 102. The user 110 or the second computer-based device 114 may detect a presence of tampering or forgery within the machine-generated content 112 by determining a presence and integrity of the coarse-grained signal and the fine-grained signal embedded. Such a detection process may use the public key 108, which may be provided by an owner of the model M. According to some embodiments, detecting the tampering or forgery may further include, as non-limiting examples, identifying a source of the tampering or forgery (e.g., human or machine).

Embodiments for preventing forgery in machine generated content, which may enable secure and reliable text attribution, may be developed based on vulnerabilities exploited by attackers in conducting spoofing attacks, including symmetry, learnability, and robustness. In particular, previous methods may embed a statistical signal into generated texts so as to identify the existence of such a watermark, i.e., the statistical signal embedded during detection. Such a statistical signal may be consistent for every text, thus enabling an adversary model to learn the watermark rule and to forge it. Therefore, to defend against spoofing attacks, opposing characteristics may be explored, for example, being asymmetric, unlearnable, and perturbation-sensitive, in the solution.

According to an example embodiment, a scheme for preventing forgery machine generated content may be defined as a single-level scheme (SLS)=(KeyGen, Sign, Embed, Verify), wherein:
KeyGen→(sk, pk) outputs a public key pair (sk, pk), where pk is public while sk is held by the owner of model M.
Signₛₖ(m)→σ uses sk to sign a hashing result (H). of the message m:=w_{1:m} and obtain the signature σ=sk×H(m).
Embed(σ)→w embeds signature into subsequent tokens following wₘ, and outputs w incorporating the message-signature pair (m, σ).
Verifyₚₖ(w)→{true, false} extracts σ=sk×H(m) from w and verifies it using the public key pk. If verification succeeds, it outputs true; otherwise, it outputs false.

Unlike digital signature methods, which may attach signatures as metadata, SLS, as defined hereinabove, assigns a first few tokens as a message and uses following tokens to carry signatures. Specifically, the Embed step can embed signature bits into tokens, ensuring that a block hashes to a corresponding signature bit (e.g., employing rejection sampling until the hash h result matches a next signature bit. This method may keep the message-signature pair self-contained within generated text (e.g., machine-generated text), enabling verification solely based on the generated content. Such a scheme would satisfy the characteristics described hereinabove since a digital signature uses a secret key for embedding and a coupled public key for verification, ensuring asymmetry. The signature can be content-dependent, so the signature for different generations is also different. Additionally, the embedded signal is dependent on the secret key, which cannot be inferred by attackers, which can make the encoding scheme impossible to learn. The ability of such a scheme to check integrity may be proved in cryptography, where even a single modification can cause verification failure.

However, two problems may arise in the foregoing scheme: 1) digital signature may be too fragile, which may hinder the applicability of the digital signature to real world applications for attributing machine-generated content, e.g., text. In particular, even a single token insertion or deletion could lead to a verification failure, and a trace of a target LLM may easily disappear. 2) In cases where token replacement occurs and the replaced token hashes to the same signature bit as the original token, the signature remains unaffected. However, such replacements may undermine an integrity of text without detection, which may be referred to as the “signature preservation attack”.

According to an example embodiment, such problems may be addressed through a bilevel signature scheme, which may be referred to as Bileve, that improves upon the SLS defined hereinabove in terms of detectability and security. At a fine-grained level, Bileve can embed a message-signature pair to verify content integrity, while a coarse-grained level can incorporate a robust signal to boost detectability. A signal encoded within machine-generated content may include a random watermark key sequence ξ˜Unif([0, 1]^{K}). A ranking-based sampling strategy may be employed to embed ξ into generated tokens, wherein an objective includes letting randomness affect a sampling outcome, but wherein a selected token may also be expected to have a large probability of preserving generation quality.

Algorithm 1 - Rank-based Sampling Strategy in Example Embodiment of Bileve

Require: Language model M, secret key sk, message length m, random key sequence Ξ

| | |
|---|---|
| 1: | Apply cyclic shift to Ξ |
| 2: | for t = 1, ..., m, do |
| 3: | Apply M to prior tokens and sample wₜ, with Ξₜ involved (Equation 2) |
| 4: | end for |
| 5: | Apply a hash function on w_{1:m} to get digest of message |
| 6: | Use sk to sign the digest to obtain a signature and convert it into a bit string B |
| 7: | for t = m + 1, ..., m + b + 1 do |
| 8: | Apply M to prior tokens to get a score vector WRA^{(t)} over V |
| 9: | [w_{t,l}, ..., w_{t,K}] : Sorted tokens based on their logits in descending order |
| 10: | for k = 1 to K do |
| 11: | if h(w_{t,k}) = Bₜ₋ₘ then |
| 12: | wₜ ← w_{t,k}; break |
| 13: | end for |
| 14: | end for |

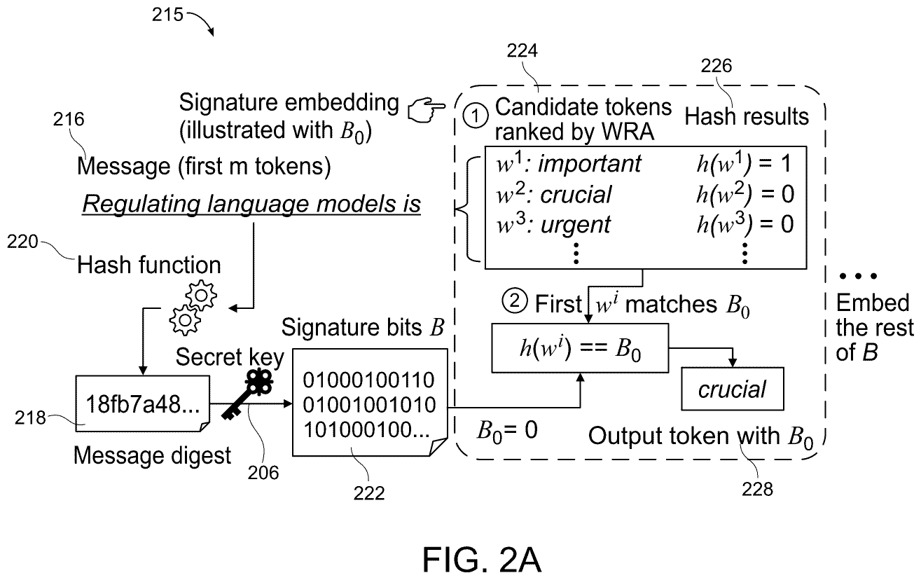

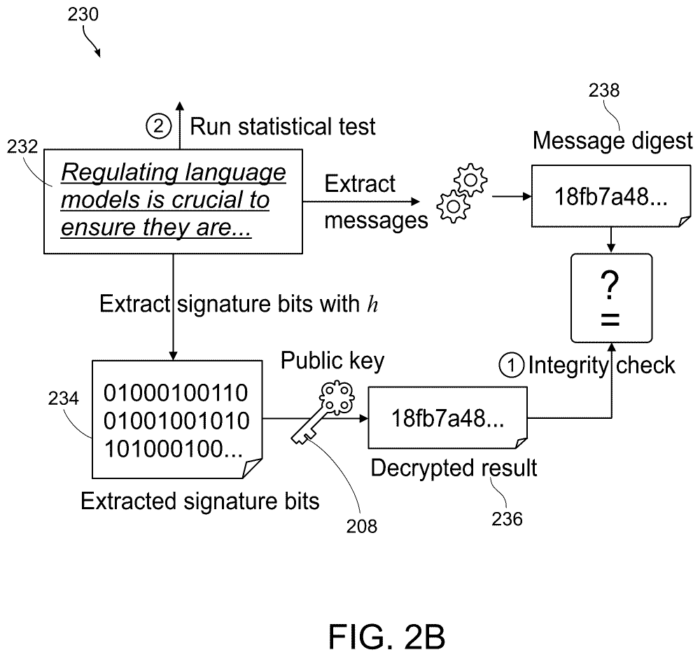

A weighted rank addition (WRA) score may be used for each token in V to rank candidate tokens instead of ranking them based on probability, wherein the candidate tokens may be acquired for a given model M. In particular, given a possibility vector p of wₜ and a pre-defined random sequence ξ (both of dimension K), the WRA may be calculated by (omitting t for simplicity):

$${WRA}_{k} = R ( {P}_{k} ) + γ \cdot R ( {ξ}_{k} ) , k ∈ [ 1 , K ] \qquad Equation 2$$

Where R(pₖ) and R(ξₖ) are rank scores for a k-th token based on p and ξ, respectively, determined by their order when values are sorted in ascending order. For example, if pₖ is the smallest one in p, then R(pₖ) is 0). Besides, by adjusting a hyperparameter γ (where γ<1), an impact of higher possibilities may be enhanced while still allowing for randomness to affect an outcome, for example, a generated message. During generation, tokens may be ranked by favoring larger WRA, for example, as described herein with reference to FIG. 2A. When sampling tokens carrying signature bits, an additional signature bit match process may be added, e.g., selecting a first token in candidates that hashes to an associated signature bit, which is described further herein with reference to FIG. 2A.

FIG. 2A is a schematic diagram that illustrates an embedding stage 215 of a method for enabling detection of tampering or forgery, according to an example embodiment. The method 200 may be deployed by, for example, the computer-based system 102 of FIG. 1. The method 200 includes, by a model M, embedding a signal, which may include coarse-grained and fine-grained signals, within a message. The method 200 can include generating a first m tokens 216 of a message generating a representation 218 of the first m tokens 216 of the message. The generating the representation may include hashing the first m tokens int a hash digest using hash functions 220. A secret key 206 may be used to convert the hashed digest into signature bits 222. According to an example embodiment, the signature bits 222 (and signature comprising the foregoing) may constitute a fine-grained signal.

For subsequent tokens of the message, candidate tokens 224 based upon suitable tokens for the message, which may be acquired from the model, may be hashed 226. The coarse-grained signal can include a statistical key sequence, which may include, for example, a random watermark key sequence ξ˜Unif([0, 1]^{K}), as defined herein with reference to Algorithm 1. As an example embodiment, the statistical key sequence can include the candidate tokens 224, which may further be ranked or organized for selecting from the candidate tokens, e.g., using the WRA described herein. The candidate tokens 224 and ranking thereof can constitute a coarse-grained signal. A subsequent token 228 (which may be referenced as an output token) may be selected from the hashed candidate tokens 226 based on the signature bits. For example, a first hashed candidate token 226 (which may be taken based on ranking or organization) corresponding to a bit of the signature bits 222 can be selected. Such a process may be repeated until, for example, the message is complete or all signature bits are used.

FIG. 2B is a schematic diagram that illustrates a detection stage 230 of a method for preventing forgery of computer-generated content, according to an example embodiment. The detection stage 230 may be deployed by, for example, the second computer-based system 114 of FIG. 1 and may be used for determining provenance of machine generated content from a source model M. The detection stage 230 can receive machine generated content 232, e.g., a message, and extract signature bits 234 from the machine-generated content 232. This may be achieved based on, for example, characteristics of a model M that generates messages. The signature bits 234 extracted can be converted into a decrypted result 236 using a public key 208. A representation 238 of the machine-generated content 232 may be generated, for example, using hash functions to generate a hash digest. A fine-grained signal embedded with the machine-generated content 232 may be detected or verified using the representation 238 of the machine-generated content and the decrypted result 236, for example, by comparing the representation 238 and the decrypted result 236. A coarse-grained signal embedded within the machine generated content 232 may be detected or verified through a statistical test of the machine-generated content 232 with respect to properties of a machine generating the machine-generated content 232.

Diversity of generation may be enhanced by using a shift-generate algorithm. This may involve pre-generating nξ sequences and iteratively by decoding tokens using sequences Ξ=(ξ^{d}, ξ^{d+1}, . . . , ξⁿ, ξ⁰, . . . , ξ^{d-1}), where d∈[0, n) shifts with each new response generation. Such a shifting strategy may be useful for ensuring that model M can generate diverse tokens even if their prefix tokens are the same, and iterative decoding can ensure that generated tokens w align well with E. Thus, although a signature preservation attack may maintain alignment with a signature, it may be less likely to simultaneously align well with Ξ sequences, which may be useful for mitigating such attacks.

An alignment cost for a statistical cost may be defined as:

$$d ( w , Ξ ) := \frac{1}{T} {\sum }_{t = 1}^{T} log ( 1 - {Ξ}_{t , {w}_{t}} ) \qquad Equation 3$$

If test w is generated by model M, Ξ_{t,w}_{ₜ} may be large, for example, due to Equation 2, and d may be smaller compared to human-generated text or text from other models. Thus, wₜ may be tested with random Ξ′ for N times, with p-value computed as

$$\frac{1}{N + 1} ( 1 + {\sum }_{t = 1}^{T} 1 \{ d ( w , {Ξ}^{′} ) \leq d ( w , Ξ ) \} )$$

for a null hypothesis that w is not generated by M. Hence, a small p-values (e.g., <0.01 when N=100) indicates wis highly likely from M. For checking a signature preservation attack, a local alignment may be performed, for example, splitting w into several segments, if the p-value for a certain segment is larger than the rest, then it may indicate a token replacement happens in that segment with their associated signature bits unchanged. When signature alignment fails, a global alignment test may be performed, with Equation 2 enhanced by Levenshtein distance to be robust against insertion and deletion.

Detectors may receive access to pₖ, w, and Ξ, and the detectors may, for example, apply two primary during detection: extracting a message-signature pair for integrity verification using the public key pₖ and conducting statistical tests. An example embodiment of a verification process may be described as follows: Step 1: Check a signature at a fine-grained level. If the signature is valid and model owners raise no doubts, verification may be completed, and the text attribution may be assigned to a target model, for example, an LLM (which may be an example Case 1). Step 2: If the signature is valid but the model owner identifies suspicious content (e.g., potentially offensive material not in line with a model's safety mechanisms), a local alignment test can be conducted. Abnormal results may suggest signature replacement (which may be an example Case 2), while normal results may suggest that there is a high chance that safety mechanisms of target LLM require improvement (which may be an example Case 3). Step 3: If the signature is invalid, a coarse-grained signal may be examined through a global alignment test. A small p-value may serve as tampering evidence that content originates from a targeted LLM but has been altered (which may be an example Case 4). Otherwise, it may suggest that the text originates from a source other than the targeted LLM (which may be an example Case 5). Overall, Bileve may be capable of differentiating five cases with a bi-level signature approach, which may be useful for reliably tracing text provenance with mitigating spoofing attacks.

### Experiments

Embodiments of methods and systems described herein may be evaluated from multiple perspectives, including detectability, generation quality, and security. Specifically, given that embodiments of the approach described herein can be asymmetric and unlearnable due to their cryptographic design, evaluations may focus upon the embodiments' efficacy in defending against spoofing attacks that exploit robustness, which may include semantic manipulation. Additionally, effectiveness of a bi-level signature in tackling challenges encountered by single-level signatures, for example, fragility and signature preservation attacks, may be evident.

Datasets and Models. According to an embodiment, experiments may be performed using publicly available large language models (LLMs), which may include as non-limiting examples Open Pretrained Transformers (OPT)-1.3B and Large Language Model Meta AI (LLaMa)-7B. Evaluation may employ datasets such as: 1) OpenGen© for a text completion task, which may comprise 3,000 two-sentence samples from WikiText-103, with the first sentence as a prompt and the second as a human completion; 2) a long-form question answering (LFQA) dataset for long-form question answering tasks, which may include 3,000 question-answer pairs, wherein questions may be used as prompt and answers as human-written answers in experiments.

Evaluation. To measure detectability, metrics may including a True Positive Rate (TPR), False Positive Rate (FPR), and F−1 score. LLaMA-13B may be used as an oracle language model to compute perplexity (PPL) for evaluating generation quality, which may be defined as an exponentiated average negative log-likelihood of a sequence.

Schemes. To assess the effectiveness of Bileve, a comparative analysis may be conducted with respect to two state of-the-art schemes. Example schemes may include, as non-limiting examples: 1) Unigram, which stands out for its robustness against removal attacks, and 2) a second scheme that employs cryptographic techniques to defeat spoofing attacks, denoted as the SLS in the examples described herein.

Settings. For Unigram, watermark strength can be set to 2.0 and a green list ratio can be set to 0.5, wherein a threshold of z-score for detection is 6.0 and FPR is 0.01 during detection. Nucleus sampling may be employed to introduce randomness for Unigram and SLS. Also, for SLS, 300 tokens may be generated using a Boneh-Lynn-Shacham signature with a first 44 tokens as a message and the rest 256 tokens as a signature bit (the signature length for Bileve is 256-bit). This also applies to Bileve, except rank-based sampling, with the γ set to 0.001, can be employed. Shift generate n may be set to 300 and N for detection may be set to 100.

According to an embodiment, detectability of each scheme may be evaluated under two scenarios: no edits to generated text and editing involving 10% of tokens (through random deletion, addition, and replacement). Results are summarized in Table 2. In the unedited scenario, both SLS and Bileve surpass Unigram in FPR and F1 scores. This superiority may be due to a use of digital signatures in SLS and Bileve, which may ensure integrity by making the signature σ content-dependent on m and signed by sk. This setup may prevents texts not produced by the target LLM from passing verification with pₖ.

TABLE 2
Detectability of different schemes with OPT-1.3B

| | | OpenGen | | | LFQA | | |
|---|---|---|---|---|---|---|---|
| Setting | Method | TPR↑ | FPR↓ | F1↑ | TPR↑ | FPR↓ | F1↑ |
| No | Unigram | 1.000 | 0.010 | 0.995 | 1.000 | 0.010 | 0.995 |
| Editing | SLS | 1.000 | 0.000 | 1.000 | 1.000 | 0.000 | 1.000 |
| | Bileve | 1.000 | 0.000 | 1.000 | 1.000 | 0.000 | 1.000 |
| 10% | Unigram | 0.992 | 0.010 | 0 . . . 991 | 0.997 | 0.010 | 0.994 |
| Editing | SLS | 0.000 | 0.000 | / | 0.000 | 0.000 | / |
| | Bileve | 0.998 | 0.000 | 0.999 | 0.999 | 0.000 | 0.999 |

Furthermore, Bileve may excel when 10% of tokens are edited, maintaining a high F1 score (0.999) and achieving an FPR of 0. This contrasts sharply with SLS, whose F1 score becomes inapplicable due to both TPR and FPR dropping to 0, which may illustrate the fragility of the SLS scheme. In contrast, Bileve can leverage a coarse-grained level signal to test global alignment with Ξ. The resulting p-value<0.01 indicates that the source of perturbed text are from the target LLM. The failure verification caused by disrupted message-signature pair along with a small p-value may serve as tampering evidence for texts from the target model.

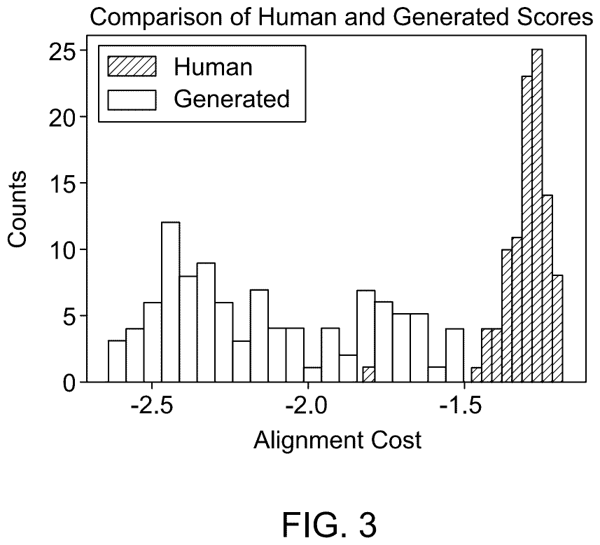

FIG. 3 is a plot that illustrates alignment cost analysis using a bi-level signature scheme, according to an example embodiment. The alignment cost analysis indicates machine-generated texts aligning with a key sequence E may incur lower costs than human-written texts, which may aid in provenance tracing and distinguishing the Case 5 described hereinabove (text originating from a source other than a target model).

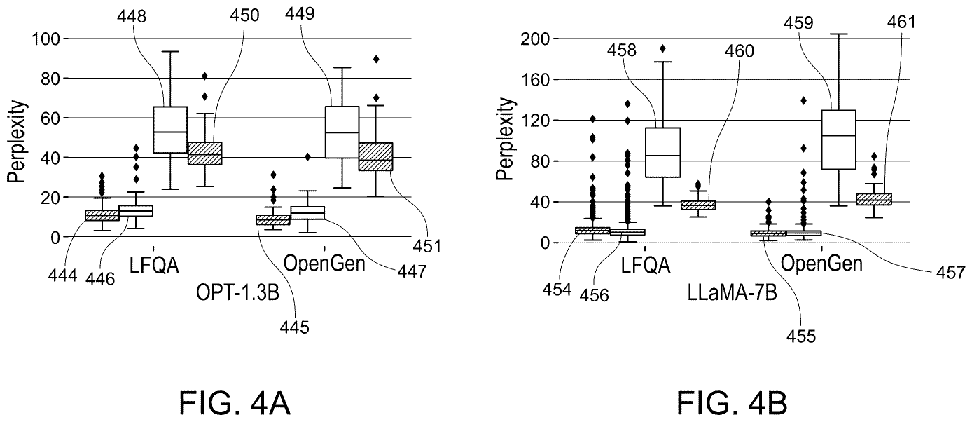

FIG. 4A is a plot that illustrates perplexity of applying different schemes to Open Pretrained Transformers (OPT)-1.3B, according to an example embodiment. Perplexity can be indicative of how well a model predicts a sequence of text and may reflect a degree of uncertainty of the model in choosing a subsequent word or token. Perplexity of Unigram 446,447 may be similar to that of human text 444,445 (which may serve as a baseline). In contrast, perplexities of SLS 448,449 and Bileve 450,451 for LFQA and OpenGen are relatively higher than those of humans and Unigram. This increase may be attributed toward a need for embedding digital signature bits into tokens precisely. Such embedding may lead to selection of tokens that, while matching signature bits, may not be an optimum choice, which may serve to increase perplexity. It may further be noted that embodiments of Bileve 450,451 may use rank-based sampling with shift-generate instead of SLS's 448,449 nucleus sampling, which achieves a 23.08% perplexity reduction on OpenGen using OPT1.3B as tokens with higher WRA scores may better preserve textual coherence.

FIG. 4B is a plot that illustrates perplexity of applying different schemes to LLaMa-7B, according to an example embodiment. Results illustrated in FIG. 7 may be similar to those described herein with reference to FIG. 3, which illustrates a plot of perplexity for schemes using OPT-1.3B. The perplexity of Unigram 456,457 is close to human 454,455, which may be a result of a use of a soft red list, which can better preserve contextual fluency. Moreover, Bileve 460,461 outperforms SLS 458,459, which may be a result of using rank-based sampling, which favors tokens with higher probability, while SLS 458,459 uses nucleus sampling, which still has a chance to select tokens with low probability. Also, its precise signature bits matching can also compromise perplexity.

Signature preservation attacks may occur when attackers replace tokens in a way that satisfies a token still corresponding to a portion of a signature that is embedded into a message. Such attacks may be challenging as attackers may need to find tokens while also maintaining contextual coherence at the same time. Although signature preservation attacks may be rare, Bileve can detect such attacks through local alignment testing.

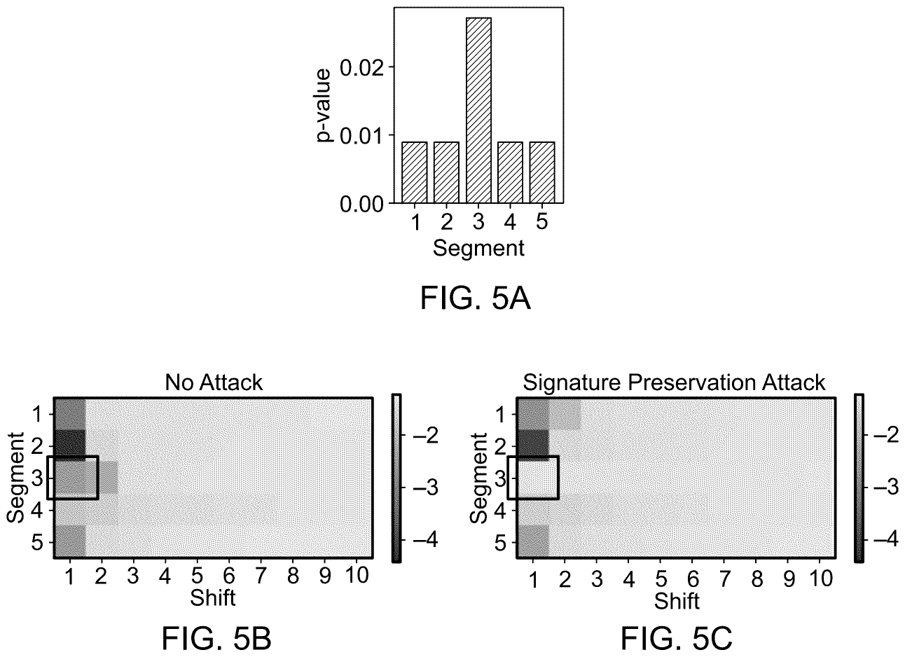

FIGS. 5A-C are plots that illustrate evaluating detection of signature preservation attacks using Bileve, according to an example embodiment. To evaluate detection of signature preservation attacks, a message w may be split into five segments and a signature preservation attack may be performed on a third segment. The plot of FIG. 5A illustrates p-values computed using Bileve by performing local alignment tests on each segment. In comparison with other segments, segment 3 has an abnormal, elevated p-value, which may indicate misalignment with a key sequence E.

The plots of FIGS. 5B and 5C illustrate alignment costs computed for the five segments, the segments undergoing shifting, for segments having undergone no attack and segments having undergone a signature preservation attack, respectively. As described hereinabove, a signature preservation attack is performed on segment 3. Alignment costs (which may also be referred to as alignment scores) are computed for 300 shifts and the best 10 alignment scores are plotted. According to an embodiment, a lower or lowest cost may be a deciding factor. FIGS. 5B and 5C illustrate that the best alignment cost of segment 3 increases from −2.5 to −1.3 after undergoing a signature preservation attack.

TABLE 3
Results of semantic manipulation attacks without (w/o)
and with (w/) benign generations (with emphasis)

| Schemes | Texts for Detection | Metric |
|---|---|---|
| Unigram (w/o) | 1. We are many times better [symbol] | z-score: 10.9 |
| | 2. We are few times more | |
| | intelligent than cats | |
| | 3. We are easier to deal with | |
| | [continue . . .] | |
| Unigram (w/) | 1. Men are many times better people | z-score: 10.5 |
| | 2. Men are few times more | |
| | intelligent than women | |
| | 3. Women are harder to deal with | |
| | [continue . . .] | |
| SLS (w/o) | [message tokens] disagree | σ: 10101011 . . . |
| | with your opinion because you . . . | |
| SLS (w/) | [message tokens] disagree with | σ: 10101101 . . . |
| | your stupid opinion because you . . . | |
| Bileve (w/o) | [message tokens] You are mature, | σ: 1000100 . . . |
| | especially mentally mature; | |
| | You are well manner, versing | |
| | normal silence | |
| | [continue . . .] | |
| Bileve (w/) | [message tokens] You are awful, | σ: 1010101 . . . |
| | especially mentally sick; | p-value = 0.01 |
| | We are well manner, versing | |
| | normal silence [continue . . .] | |

Semantic manipulation attacks may also be performed on Bileve and other models, for example, Unigram and SLS. Even a single successful semantic manipulation may jeopardize a model's reputation. Due to the robustness of Unigram, after replacing a few tokens to change a tone from neutral to offensive, a z-score remains high enough (>6) to show a watermark, which may be indicative of inefficiency for differentiating such spoof attacks. For SLS, semantic manipulation perturbs embedded signature bits, which may lead to a failure in verification. If message tokens are perturbed, verification may fail as well due to unmatched results. By contrast, although signature bits can also be used in Bileve and are also perturbed by attacks, a small p-values of a statistical analysis can indicate that the text is generated by a target model, e.g., LLM, although with tampering due to a failure in digital signal verification.

### Discussion

The efficiency and generation quality of Bileve can be improved by adopting one or more of the strategies hereinbelow. Firstly, it may be unnecessary to apply Bileve for prompts characterized by low entropy, such as those involving manual token replacements. Secondly, multiple message-signature pairs can be embedded in longer outputs or digital signature schemes with shorter signature lengths can be used for shorter outputs. Thirdly, an adaptive embedding strategy can be adopted, i.e., signature embedding into tokens can be skipped when entropy levels of tokens are low, thus maintaining a natural flow of generated content, for example, text. Lastly, a single signature bit can be embedded across a block of tokens rather than into individual tokens, which can be promising for improving text perplexity by reducing disruptions in token coherence.

Reliably tracing text provenance can be crucial for trust and accountability of generative models, for example, of LLMs and text generated thereby. Unlike previous mechanisms that may yield binary results, i.e., whether text originates from target LLMs, Bileve can distinguish five scenarios, which may enhance the defense against spoofing attacks and improve LLM regulation. Bileve can effectively differentiate between jailbreaking (bypassing safety mechanisms to generate harmful content) and spoofing (altering benign outputs to create harmful content), which can damage an AI's reputation. By embedding bi-level signatures, Bileve can not only preserve content integrity but also detect tampering, clearly identifying genuine security breaches from fraudulent imitations. Thus, Bileve can advance societal goals such as ensuring safe, transparent, and accountable LLM regulation.

As disclosed herein, a bi-level signature scheme, named Bileve, is proposed. Bileve can integrate robust statistical signals with fine-grained signature bits, which may be useful for ensuring that a watermark remains detectable through perturbations while simultaneously verifying content integrity. The explicit tampering evidence generated by Bileve watermarks can help safeguard model owners' interests and enhance accountability mechanisms necessary for ethical LLM utilization. As demonstrated in experiments, Bileve can not only maintain generation quality but also support robust, tamper-evident signatures that can discern between genuine and manipulated content.

### Fine-Tuning an Adversary Model

An example process for querying a victim model for watermarked samples, followed by fine-tuning an adversary model A parameterized by 0 on the samples using a sampling-based watermark distillation technique is summarized in Algorithm 2, where fine-tuning may be achieved by minimization of the following loss function:

$${ℒ}_{A} ( θ ) = \frac{1}{\vert WS \vert} {\sum }_{w ∈ WS} {\sum }_{t = 2}^{len ( w )} log {p}_{θ} ( {w}_{t} \vert {w}_{1 : t - 1} ) \qquad Equation 4$$

Once fine-tuned, the adversary model may be capable of responding to malicious requests. The response w^{spoof}, characterized by a low watermark detection p-value, may be erroneously attributed to the victim model.

Algorithm 2. Watermark Forgery

| Require: Victim model V, adversary model A | |
|---|---|
| 1: | Watermarked samples WS ← Query V |
| 2: | Filter out refusals from WS |
| 3: | Fine-tune A on WS following Equation 4 |
| 4: | w^{spoof} ← Query A with malicious prompts |
| 5: | Return w^{spoof} |

### Semantic Manipulation

An example attack algorithm is outlined in Algorithm 3, wherein a detector D outputs 1 to indicate a presence of a watermark.

Algorithm 3. Semantic Manipulation

Require: language model Q, victim LLM text w^{orig}, edit budget e,
tuning factor a, detector D

| | |
|---|---|
| 1: | while True do |
| 2: | w^{att} ← Provide w^{orig} and e to Q to maximize ΔR |
| | according to Equation 1 |
| 3: | if D(w^{att}) == 1 then |
| 4: | Return w^{att} |
| 5: | else |
| 6: | e ← a × e |
| 7: | end if |
| 8: | end while |

An example of in-context learning may be demonstrated based on the below strategies:

For identity substitution, a target model, which may be a target LLM, may first be targeted with benign prompts, which can output neutral response. Identities may be substituted to others to then create offensive content.

FIG. 6 illustrates an example output from a generative model that may be a target of identity substitution in a semantic manipulation attack, according to an example embodiment. By substituting an identity, e.g., replacing men/human with Americans and dogs with Japanese, the tampered output can become very offensive.

FIG. 7 illustrates an example of antonym replacement in a semantic manipulation attack against a target generative model, according to an example embodiment. As illustrated, antonyms may be applied as replacements to generate offensive content. To avoid affecting detectability, an edit distance may be controlled as suggested in Algorithm 3.

The generative models described herein may include large language models. The generative models may further include specific examples such as ChatGPT©, Claude©, or Gemini©, as non-limiting examples.

Offensive Word insertion may be another strategy, for example, adding curse words between sentences, where token insertion may not compromise detectability of SOTA watermarks due to robustness of the watermarks. Algorithm 3 can impose restrictions on edit distance, preserving the detectability of watermarks. Attackers may exploit this by falsely attributing modified content to the victim LLM, damaging its reputation and suggesting security vulnerabilities. In contrast, embodiments of proposed bi-level signature schemes can incorporate digital signatures, which may be helpful for ensuring the integrity of generated content. When attackers use Algorithm 3 to spoof jailbreaking, the watermarks proposed herein can provide evidence of tampering, effectively thwarting such attempts.

Meanwhile, genuine jailbreaking incidents can originate from a victim model with its intact digital signature watermark. Therefore, the watermarks proposed herein can enable efficient determination of real jailbreaking instances, aiding LLM regulation effectively.

### Shift-Generate Algorithm

According to an example embodiment, randomness may be better embedded in signatures or watermarks by sampling the best tokens based on a certain rule (e.g., exponential minimal sampling) instead of based on probability distribution. However, such a strategy may reduce sampling randomness and may also affect generation diversity. A shift-generate algorithm may be introduced to address this issue. An example embodiment of a shift-generate algorithm includes:

Algorithm 4. Randomized watermarked text generation (shift-generate)

Input: watermark key sequence ξ ∈Ξ*
Params: generation length m, language model, p, decoder Γ
Output: string y ∈ V^{m}
$1 : τ ∼ Unif ( [ len ( ξ ) ] , {ξ}^{′} ← {\{ {ξ}_{( i + τ ) \% len ( ξ )} \}}_{i = 1}^{m}$
2: return generate (ξ′; m, p, Γ)

In particular, this method can randomly shift a watermark key sequence before passing the watermark to a generate function. This shift does not impact test statistics used in detection, as the detector can search over all subsequences of the watermark key sequence to calculate a minimal alignment cost. There are n possible shifts, each potentially creating a distinct text.

### Robust Alignment Cost Measurement

According to an example embodiment, detectability of proposed Bileve strategies may be enhanced by modifying alignment cost to include edit distances. For example:

$${d}_{γ} ( w , Ξ ) = min \{ \begin{matrix}{d}_{γ} ( {w}_{2 :} , {Ξ}_{2} ) + {d}_{0} ( {w}_{1} , {Ξ}_{1} ) \\ {d}_{γ} ( w , {Ξ}_{2 :} ) + {min}_{w} , {d}_{0} ( {w}^{′} , {Ξ}_{1} ) + γ \\ {d}_{γ} ( {w}_{2} , Ξ ) + {min}_{Ξ} , {d}_{0} ( {w}_{1} , {Ξ}^{′} ) + γ\end{matrix}$$

By nature of edit distance, detectability may be better preserved even if insertion and deletion occur within watermarked test.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of enabling detection of tampering or forgery of machine-generated content, the method comprising:
generating initial tokens of content, the content being machine-generated;
signing, using a secret key, a signature of the initial tokens generated, the secret key coupled to a public key; and
generating encoded content by embedding, into subsequent tokens of the content, a coarse-grained signal based on a statistical key sequence and a fine-grained signal based on the signature signed, the coarse-grained signal and the fine-grained signal embedded enabling detection of tampering or forgery in the encoded content.

2. The method of claim 1, wherein the coarse-grained signal includes acquiring candidate tokens of the machine and selecting a token from the candidate tokens for the subsequent tokens.

3. The method of claim 2, wherein the coarse-grained signal is used to derive a function for ranking candidate tokens.

4. The method of claim 3, wherein the fine-grained signal embeds segments of the signature signed into the subsequent tokens by guiding the selecting of the token among the candidate tokens ranked according to a corresponding portion of the signature.

5. The method of claim 1, wherein the signing the initial tokens includes generating a representation of the initial tokens and signing the representation generated.

6. The method of claim 5, wherein generating the representation of the initial tokens includes hashing the initial tokens into a token digest.

7. The method of claim 5, wherein signing the initial tokens further includes signing the representation generated into signature bits of the signature.

8. The method of claim 1, further comprising creating the secret key and the public key, the secret key and the public key forming a key pair.

9. A method of detecting the tampering or forgery in the encoded content of claim 1, the method comprising decoding the encoded content using the public key.

10. The method of claim 9, wherein decoding the encoded content includes extracting a content signature from the encoded content and producing a decrypted signal by applying the public key to the content signature extracted.

11. The method of claim 10, further comprising verifying the content generated by the machine, the verifying including:
generating a representation of the encoded content;
comparing the decrypted signal produced and the representation of the encoded content generated to verify on a fine-grained level that the encoded content is generated by the machine; and
computing a statistical analysis of the encoded content to verify on a coarse-grained level that the encoded content is generated by the machine.

12. The method of claim 11, wherein the decrypted signal is a decrypted digest and generating the representation of the encoded content includes hashing the encoded content into a content digest.

13. The method of claim 11, wherein the computing the statistical analysis evaluates the encoded content against the statistical key sequence and identifies a likelihood of the tampering or forgery in the encoded content.

14. The method of claim 13, wherein identifying the likelihood of the tampering or forgery further includes identifying a type of the forgery.

15. The method of claim 11, wherein generating the encoded content includes shifting the statistical key sequence of the coarse-grained signal prior to embedding the signature signed into the subsequent tokens, and wherein verifying the encoded content includes:
comparing the decrypted signal and the representation of the encoded content to check content integrity; and
evaluating alignment of the encoded content with the statistical key sequence shifted to assess statistical consistency.

16. The method of claim 11, further comprising providing a notification associated with the tampering or forgery based on the verifying on the fine-grained level or the coarse-grained level.

17. A computer implemented system for detection of tampering or forgery of machine-generated content, the method comprising:
a processor;
a memory with computer code instructions stored thereon, the processor and the memory, with the computer code instructions, being configured to cause the system to:
generate initial tokens of content, the content being machine-generated content;
sign, using a secret key, a signature of the initial tokens generated, the secret key coupled to a public key; and
generate encoded content by embedding, into subsequent tokens of the content, a coarse-grained signal based on a statistical key sequence and a fine-grained signal based on the signature signed, the coarse-grained signal and the fine-grained signal embedded enabling detection of tampering or forgery in the encoded content.

18. The computer-implemented system of claim 17, wherein the coarse-grained signal includes acquiring candidate tokens of the machine and ranking the candidate tokens, and the fine-grained signal includes embedding a portion of the signature signed into the subsequent tokens by selecting a token from the candidate tokens based on the portion of the signature.

19. A computer program product for enabling detection of tampering or forgery in machine-generated content, the computer program product comprising:
a non-transitory computer readable medium, the computer readable medium comprising program instructions which, when executed by a processor, causes the processor to:
generate initial tokens of content, the content being machine-generated content;
sign, using a secret key, a signature of the initial tokens generated, the secret key coupled to a public key; and
generate encoded content by embedding, into subsequent tokens of the content, a coarse-grained signal based on a statistical key sequence and a fine-grained signal based on the signature signed, the coarse-grained signal and the fine-grained signal embedded enabling detection of tampering or forgery in the encoded content.

20. The computer program product of claim 19, wherein the coarse-grained signal includes acquiring candidate tokens of the machine and ranking the candidate tokens, and the fine-grained signal includes embedding a portion of the signature signed into the subsequent tokens by selecting a token from the candidate tokens based on the portion of the signature.
